(19) United States
(12) Patent Application Publication
(10) Pub. No.: US 2009/0083125 A1
(43) Pub. Date: Mar. 26, 2009

(54) Method and Apparatus for Rewarding Consumer Interaction with Electronic Information

(76) Inventors: William A. Yasnoff, Arlington, VA (US); Sherman J. Muller, Centennial, CO (US)

Correspondence Address: FITCH EVEN TABIN AND FLANNERY, 120 SOUTH LA SALLE STREET, SUITE 1600, CHICAGO, IL, 60603-3406, US

(21) Appl. No.: 12/014,174

(22) Filed: Jan. 15, 2008

Related U.S. Application Data
(60) Provisional application No. 60/995,070, filed on Sep. 24, 2007.

(51) Int. Cl. G06Q 30/00; G06Q 10/00

(52) U.S. Cl. 705/10; 705/14; 705/7

(57) ABSTRACT

These teachings provide for automatically tracking (102) an enrolled visitor's website visiting behaviors after determining (101) whether a website visitor is an enrolled visitor and automatically crediting (103) an account for the enrolled visitor. A compensatory reward related to tracked website visiting behaviors is provided (106).

### RELATED APPLICATION(S)

This application claims the benefit of U.S. Provisional application No. 60/995,070 filed Sep. 24, 2007, which is incorporated by reference in its entirety herein.

### TECHNICAL FIELD

This invention relates generally to advertising and more particularly to Internet advertising.

### BACKGROUND

Internet advertising or online marketing, in a variety of forms, is well known in the art. Such web-based advertising may include, for example, search engine marketing including social media optimization, display advertising, e-mail marketing, affiliate marketing, interactive advertising, blog marketing, and viral marketing. By one approach, display advertisements provide a variety of images sometimes incorporating audio and video elements, for example using Adobe Flash, to create popups, web banners, and video clips, to note but a few. Internet advertising is becoming increasingly important for a number of reasons, including the availability of new technology that may decrease the effectiveness of more traditional marketing methods. For example, in addition to an increasingly fractured and ever-growing number of broadcasting sources, the increasing ability and willingness of content consumers to record television shows on digital video recorders (DVRs) allows users to watch recorded programming but forward through the commercials.

Internet advertising sponsors typically pay the web site owner for placement of advertisements and there are a number of advertising pricing models including pay-per-click, cost-per-action, and pay-per-impression, to note but a few. Generally, revenue generated is at least somewhat dependent on the frequency with which the advertisement is viewed by consumers. Web sites generating significant revenues from such advertising include, for example, web-based search engines, such as GOOGLE, YAHOO, and various electronic news media. Depending on the amount of web traffic at a web site, substantial amounts of revenue may be generated.

Whether due to the first mover advantage, the advantages afforded fast followers or second movers, or user force of habit, it is often difficult for newly launched web sites to acquire new users. More particularly, when a web site has established a high level of traffic for a type of service, newer options may struggle to draw users from the established web site, even if the newer web site offers features not available on the established web site. As is generally understood, acquiring high levels of web traffic is important because the price of web-based advertising is often dependent on both traffic and the surrounding web content.

Several online advertising pricing models are based on performance of the advertisement such as the number of clicks or purchases originating therefrom. By one approach, an advertiser may pay a few cents for every click on their advertisement or every impression of the advertisement. By yet another approach, the advertiser may pay for each specified action completed such as a sale or a registration or acquisition. This may include paying the web site a certain percentage of the sales revenue resulting from the web visitor being referred by the web site, for example by clicking through an advertisement or a link. Regardless of the pricing models, the revenue generated for the advertiser is typically incrementally small, sometimes on the order of a fraction of a cent per click. Thus, a significant quantity of desired actions (such as, for example, views, clicks, purchases, or the like) is typically required for the advertiser to collect a modest financial reward. To increase the incidence of the desired performances or behaviors, it is often beneficial to display content that is targeted to particular web users. For example, depending on the web user's age, gender, and interests, more appropriate advertisements may be chosen to be displayed.

Contextual advertising has become widely used to display targeted advertisements to web users. However, this method is typically limited by the information that is readily available such as the terms recently searched by web users and assumptions generally attributed to web users who typically search for such terms. These methods have a significant degree of uncertainty and generally not enough information is known about the consumer to create a more nuanced or targeted advertising approach. As one simple illustrative example in this regard, it will not be certain whether someone searching for information on “machu picchu” is also in the market for a vacation.

To more effectively target their advertising messages, web sites may use the information available about each web user to associate and then display particular advertising messages to certain types of individuals. Since it is difficult for current systems to automatically glean more information about each user, new methods are needed to gather the information such as, for example, encouraging consumers to provide such information to web site operators. Requesting that a web user voluntarily supply personal information is one approach to obtaining the desired information. As a result, the web user benefits by being exposed to advertising messages that are more relevant to his or her individual interests and needs. But this modest benefit is not sufficient for most web users, so web site operators need new and innovative ways to provide consumers with incentives to supply personal information that may be used to improve how advertising messages are targeted to consumers. In addition to improving advertising effectiveness and increasing the likelihood that a message will be viewed (and acted on) by directing particular messages to particular individuals, web site operators may also benefit from new and innovative methods for increasing the attractiveness of their advertising messages. Finally, newly launched web sites are particularly interested in increasing web traffic. More particularly, they are interested in methods that encourage more web users to visit their sites and interact with online advertising in order to increase their revenue.

### BRIEF DESCRIPTION OF THE DRAWINGS

The above needs are at least partially met through provision of the Method and Apparatus For Rewarding Consumer Interaction With Electronic Information described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention; and

FIG. 4 comprises a schematic block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, upon verifying that a website visitor is an enrolled visitor, the enrolled visitor's website visiting behaviors pertaining to certain selected behaviors are tracked. Based on the tracked website visiting behaviors, an account for the enrolled visitor is automatically credited. A compensatory reward related to tracked website visiting behaviors is then provided.

As discussed below, tracking of website visiting behaviors tracks or registers the consumer's interaction (such as clicking or viewing) with advertising content. By one approach, tracking of a visitor's website visiting behaviors may include tracking web content exposure events such as the duration of an enrolled visitor's exposure to content at a given website or selecting a webpage containing particular content including advertising content. By another approach, undesired behaviors may be automatically tracked and pejorative actions taken with respect to the enrolled visitor's account.

So configured and arranged, these teachings facilitate rewarding a consumer's interaction with electronic information by determining whether a website visitor is an enrolled visitor, automatically tracking their on-line behaviors, and compensating the enrolled visitor based on the tracked quantity in the enrolled visitor's account. By compensating the consumer based on their web visiting behaviors, website visitors have an economic incentive to become an enrolled visitor. This in turn may lead to increase web traffic and the resulting economic advantage that accompanies such an increased Internet presence. In addition, by tracking Internet users' website visiting behaviors and combining that information with demographic information obtained from the website visitor, the advertisements can be more effectively targeted to particular enrolled visitors. Since these teachings are independent of the online advertising pricing model (such as cost per sale, cost per action, pay per click, pay per impression, to note but a few) these teachings accommodate a number of application settings and are sufficiently flexible to reward consumers for their interaction within a plurality of advertising pricing paradigms.

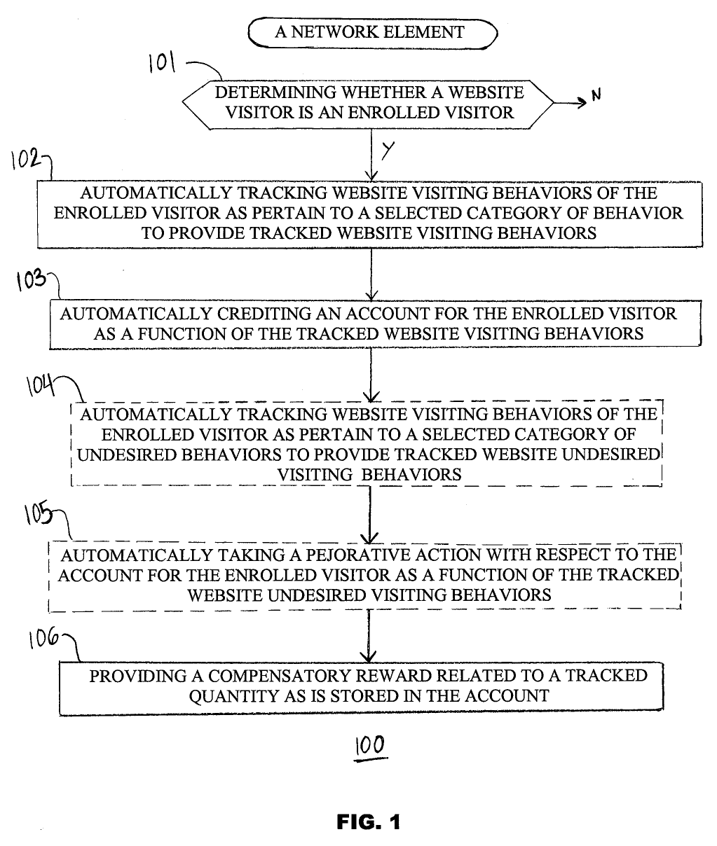

These and other benefits may become clearer upon making a thorough review and study of the following detailed description. Referring now to the drawings, and in particular to FIG. 1, an illustrative process that is compatible with many of these teachings will now be presented. The illustrated process 100 provides for determining 101 whether a website visitor is an enrolled visitor and automatically tracking 102 the website visiting behaviors of the enrolled visitor. To become an enrolled visitor, the website visitor may sign up by following a corresponding registration process.

In one illustrative example, the registration process includes obtaining information from the website visitor, such as the visitor's name, address, demographic information, preferences, interests, and/or health history, to note but a few. By one approach, at least information sufficient to provide the compensatory reward is collected from the enrolling visitor. For example, a website visitor may choose to be compensated by receiving a check for the amount credited to their account once a month, once a year, or pursuant to some other standard of periodicity as may be desired. Thus, information sufficient to issue and deliver the check would need to be obtained from the website visitor. (As used herein, the expression “check” will be understood to refer to a financial instrument that instructs a financial institution (such as a bank, a savings and loan, a credit union, or the like) to pay a specific amount of a specific currency from a specific demand account held in a particular entity's name with that institution, and will further be understood to comprise either a physical document or an instruction and authorization to make a direct deposit of the specified amount into an identified account for the payee.)

As used herein, the expression “website visitor” will be understood to include a visitor connecting to the Internet via essentially any compatible platform including via a mobile telephone, a personal digital assistant (PDAs), a laptop or desktop computer, and so forth, to note but a few examples in this regard. Further, the term “Internet,” as used herein, will be understood by those skilled in the art to refer to a communication network that relies on Internet Protocol (IP) based communications.

In addition to receiving information from the enrolling visitor, the registration process can allow the website visitor to create an enrolled visitor account. By one approach, the enrolled visitor sets up a personal identifier to be used to determine 101 whether a website visitor is an enrolled visitor having an enrolled visitor account. The account is credited as a function of the enrolled visitor's tracked website visiting behaviors. Such an account may be managed by assigning the enrolled visitor and the associated account a user name and password. By one approach, the enrolling visitor may be provided a questionnaire or survey to obtain additional information such as that information which may be of interest to various advertisers. By another approach, enrolled users may be given the opportunity to receive and respond to additional or supplemental questionnaires after the initial sign-up, thereby compiling additional information or updating the enrolled visitor's account, demographic data, behavioral data, and/or other information of interest.

After the enrolled visitor has signed in to their account, the visitor's website visiting behaviors are tracked. In addition, since the website has received demographic information from the enrolled visitor, advertisements targeted at the visitor's demographic may be displayed. Such a targeted advertisement display may affect the pricing of the advertising model. For example, a company selling baby formula may pay a premium to display its advertisement to consumers who have infants in their household.

The ability to target specific visitors having particular demographics with corresponding advertisements is becoming increasingly important in part due to the use of dynamic screen presentations to support more easily altering advertisements (or other content) in view of the audience. For example, the use of dynamic content selection and placement techniques in combination with available graphics rendering capabilities may allow the virtual placement of products within various types of media. Conventional product placement occurs during the production of the movie and television show, among others. However, virtual placement employs computer graphics capabilities to place the product within a given scene after the program is otherwise complete. This provides advertisers with great flexibility with respect to product placement. For example, for a given video clip, the product placement can be dynamic such that one product may be switched with another based on the target audience.

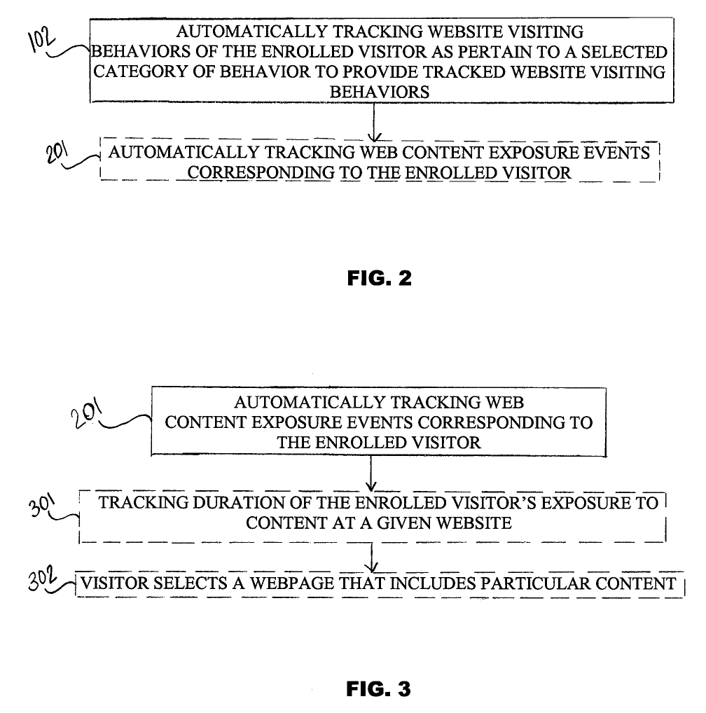

As mentioned, the website visiting behaviors of the enrolled visitor that are automatically tracked 102 are those pertaining to a selected category of behaviors. Turning now momentarily to FIG. 2, automatically tracking 102 the enrolled visitor's website visiting behaviors pertaining to selected categories may include automatically tracking 201 the enrolled visitor's exposure to particular web content. By one approach this can comprise noting when the visitor has downloaded a particular screen containing particular content of interest in this regard (such as a screen containing a particular advertisement). By another approach, this can comprise noting when the visitor has clicked on some portion of their display that corresponds in some particular way with such content of interest. Those skilled in the art will understand and appreciate that other possibilities exist in this regard as well.

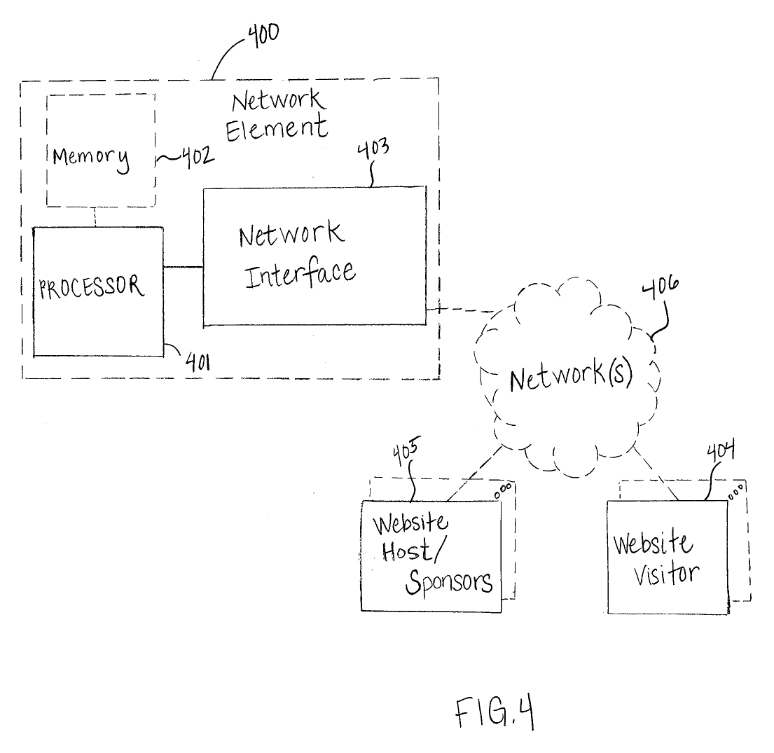

By another approach, and referring now momentarily to FIG. 3, tracking of the enrolled visitor's exposure may include tracking 301 the duration of time that the visitor is exposed to particular content at a given website. For example, upon opening a webpage, an advertisement may be displayed and a link “skip this ad” may accompany such an advertisement. The website may track the duration of the visitor's exposure to the website before the advertisement concludes or the website visitor selects the “skip this ad” link. In addition, the web content exposure for a given visitor may include the enrolled visitor selecting 302 or clicking on a webpage that includes the particular content. For example, the website may track whether a link that directs the visitor to an advertiser's webpage is selected.

As suggested, selected categories of behaviors are generally related to advertising content. Such advertising content is understood herein to refer to advertisements as well as other methods of promoting the product, brand, or company, such as product or brand placement and brand integration, to note but a few examples in this regard. Those skilled in the art will recognize that other kinds of content may be selected for corresponding treatment if desired. For example, if desired, these teachings might be employed in conjunction with the presentation of educational materials and where the described processes serve to encourage a given visitor into being exposed to such educational materials.

In addition to the previously discussed selected categories of behaviors to be tracked, other web viewing behaviors may be of interest to marketers and such behaviors may be monitored in addition to the desired behaviors. Consumers' behavioral information used in conjunction with demographic information may be valuable to a variety of marketing efforts including product development, service promotion, distribution, and evaluation of advertising effectiveness, to note but a few.

By one approach, after a website visitor has confirmed status as an enrolled visitor, the visitor's website visiting behaviors may be tracked at any of a plurality of websites. Such websites may be administratively unrelated. Further, the enrolled visitor's account may be automatically credited as a function of the website visiting behaviors that were tracked at the plurality of administratively unrelated websites. Tracking behaviors at the administratively unrelated website allows the enrolled visitors to be given credit for their web viewing despite the administrative status of a given web site.

Returning now to FIG. 1, the process 100 includes automatically crediting 103 an account established for the enrolled visitor. The amount credited is typically a function of desirable tracked website visiting behaviors such as, for example, content viewed, links selected, products or services purchased, a duration of exposure, among others. In addition, characterizing information such as demographic or behavioral information may factor into the amount credited to the enrolled visitor's account. For example, whether or not an account is credited may depend on whether the enrolled visitor falls within a certain demographic classification, range, group, or the like.

Further, if desired, the amount credited may change as a function of various items of characterizing information. For example, an advertiser may pay a premium for a video clip to be played for certain visitors and thus the account for that visitor may be credited on a premium basis when viewing that particular video clip. In addition to demographic or behavior information, other characterizing information may include a credit report for the enrolled visitor, reported income for the enrolled visitor, and a reported occupation for the enrolled visitor, among others.

In one illustrative example, this characterizing information can comprise health care information. If an enrolled visitor is presently afflicted with a certain health condition, then advertisers may be more interested in providing particular advertising information to that visitor. As used herein, such a condition will be understood to comprise any of a physical and/or mental disease, abnormality, or impairment. Health care information may also include:
a condition with which the enrolled visitor has previously been afflicted;
a condition for which the enrolled visitor has an increased or decreased genetic predisposition;
a condition with which a relative of the enrolled visitor is afflicted;
a condition with which an acquaintance of the enrolled visitor is afflicted;
whether the enrolled visitor is a primary condition caregiver;
the medications prescribed for the enrolled visitor;
a health condition laboratory test ordered or result for the enrolled visitor;
a health condition imaging test ordered or result for the enrolled visitor;
an allergy of the enrolled visitor;
a preventative health intervention status for the enrolled visitor;
an immunization status of the enrolled visitor including those immunizations already received or those that may be required in the future;
a specific health care services provider who has provided health care services to the enrolled visitor;
a specific health care services provider specialist who has provided health care services to the enrolled visitor;
a medical procedure status for the enrolled visitor;
the health insurance status of the enrolled visitor;
risk factors for a condition as it relates to the enrolled visitor;
a dietary regimen of the enrolled visitor including sensitivities and intolerances, along with regimens designed to affect a health condition;
a geographic location visited by the enrolled visitor;
a geographic location the enrolled visitor is planning to visit; and
participation status of the enrolled visitor in a medical research study; to list a few.

With continued reference to FIG. 1, the process 100 may also include automatically tracking 104 undesired website visiting behaviors of an enrolled visitor and automatically taking 105 a pejorative action with respect to the account for that enrolled visitor. Such pejorative action may include cancelling the account, deducting any amount credited due to undesired behaviors, and freezing the account, among others. Other possibilities include providing a warning notice to the enrolled visitor to advise them of the undesirability of their behavior and/or the potential or actual consequences that will occur if such behavior persists.

Various behaviors can be categorized as being undesirable with the specifics likely changing from one application setting to another. These teachings will readily accommodate identifying one or more of the following behaviors as comprising an undesirable behavior if desired:

excessively high clicking frequencies (where “clicking” will be understood to refer to a cursor selection tool manipulation by which a given user indicates a selection of a particular link, button, or other selection opportunity);

excessively large numbers of clicks within a given time period (such as one second, ten seconds, one minute, or the like);

large numbers of repeat clicks on the same item;

a failure of the website visitor to pass a screening test that tests if clicks are being automatically created;

large numbers of clicks for a given website visitor from an excessive variety of Internet Protocol (IP) addresses;

simultaneous (or nearly simultaneous) clicks by a single enrolled visitor in multiple sessions; and/or

clicking events that occur without interruption for too long a time period;

to list but a few. Those skilled in the art will recognize that other possibilities exist in this regard as well. Tracking and responding to these undesirable behaviors may help quell and discourage automatic clicking programs and restrict the compensatory reward to valid human use.

As shown in FIG. 1, the process 100 also makes provision for providing 106 a compensatory reward related to tracked website behaviors. This reward may be provided to the website visitor in a variety of forms of currency including the payment of legal tender, discounts, rebates, redeemable points (such as so-called frequent flier miles and other customer loyalty program-based points or the like), and other mediums of exchange that may be applied online or elsewhere, and so forth, to note but a few examples in this regard. By one approach, the compensatory reward may be in the form of virtual currency (for example, virtual currency such as that used in a virtual gaming world such as the Second Life Linden dollar). By another approach, the compensatory reward may include a promissory note, a check, cash, a direct debit deposit, an account credit, a bank transfer, and/or a share of a stock (including whole, fractional, or otherwise), to note but a few of the numerous compensation options.

As discussed above, each individual tracked desired behavior may individually amount to only a very small amount such as a fraction of a cent. Pursuant to these teachings, however, the tracked website visiting behaviors are aggregated together such that eventually the corresponding micropayments may be sufficiently large enough to justify (at least on a cost basis) making a payment by issuing a check or otherwise rendering legal tender or other compensation to the intended recipient.

Due to varying degrees of respective Internet usage, various enrolled visitors may have accounts with widely differing accumulated amounts therein. In such a case, and by one approach, issuance of the compensatory reward provided to the website visitor may be controlled or otherwise triggered as a function of having at least a predetermined threshold value.

By one approach, some or all of the compensation related to the tracked website visiting behaviors may be provided to a third party as specified by the website visitor. In one illustrative example, the enrolled visitor's account can be set up to direct the compensatory reward to a third party such as a specific charitable organization, an alma mater, a governmental agency, a family, or a find, among others.

To encourage legitimate, desired website visiting behaviors, the compensatory reward provided to a particular website visitor could be determined based on statistical information regarding other website visitors' tracked website visiting behaviors. Using this approach, this statistical information may be used, for example, to influence the compensatory reward for the website visitor. By one example, the compensatory reward for a group of enrolled visitors may be based on the average click behavior of a group of similar enrolled visitors. Averaging the click behavior of similar users may decrease the incentive and/or the benefit to game the system or click largely for compensation alone.

To illustrate, it may be statistically evident during some particular period of time that visitors who exceed 500 content exposure events in a seven day period have, on average, 773 content exposure events. This value of 773 could then be used in various ways to influence the amount of compensation being provided to such a visitor as per these teachings. By one approach, for example, each visitor with more than 500 content exposure events under these circumstances may be provided with a compensatory reward that is based upon 773 content exposure events regardless of each individual visitor's actual behavior results (so long as they exceed the threshold 500 content exposure events). Other ways of employing such a value towards these same purposes are possible as well as will be understood by those skilled in the art.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform will now be provided. By one approach, a facilitating network element 400 may include several components, such as a processor 401 that may operably couple to a memory 402 and to a network interface 403. The network interface 403 may be configured and arranged to receive information from an end user (with many examples in this regard being known in the art and with others being likely to be developed in the future: these teachings are generally suitable for use with any such examples). In this example, the network element 400 operably couples to a network(s) 406 that itself is operably coupled to one or more website hosts or sponsors 405 and one or more website visitors 404.

Those skilled in the art will recognize and appreciate that such a processor 401 can comprise a fixed-purpose hard-wired platform or can comprise a partially or wholly programmable platform. All of these architectural options are well known and understood in the art and require no further description here. The processor 401 is configured and arranged (via, for example, corresponding programming as will be well understood by those skilled in the art) to determine whether a given website visitor 404 is an enrolled visitor. This website visitor 404 may connect though the aforementioned network 406 and/or the network interface 403.

If the website visitor is not an enrolled visitor the processor 401 may direct the website visitor to a registration page for the website visitor to become an enrolled visitor. This registration page may be operated and facilitated by the processor 401 itself or may be operated and facilitated by another entity as desired.

After determining that a website visitor is an enrolled visitor, the processor 401 is configured and arranged to automatically track the website visiting behaviors of the enrolled visitor. Such tracked website visiting behaviors include those pertaining to a selected category such as an enrolled visitor's exposure to certain web content as discussed above. The processor 401 may also automatically credit an account for the enrolled visitor as a function of the tracked website visiting behaviors. Based on the tracked quantity of website visiting behaviors stored in the account, a compensatory reward is then provided.

So configured, those skilled in the art will recognize and appreciate that these teachings provide a mechanism and approach whereby individual content consumers, including website visitors, are incentivized to provide personal information and accept exposure to specific kinds of content. By this approach, for example, advertisers can be better assured that their messages are reaching an accepting audience. This can be particularly powerful when combined with other information such as demographic information regarding the content consumers. In such a case, a given advertiser can be better assured both that their particular message is being directed to a relevant candidate for that message and further that this particular candidate has actually accepted willing exposure to the message itself.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network element:
determining that a website visitor is an enrolled visitor;
upon determining that the website visitor is an enrolled visitor:
automatically tracking website visiting behaviors of the enrolled visitor as pertain to a selected category of behavior to provide tracked website visiting behaviors;
automatically crediting an account for the enrolled visitor as a function, at least in part, of the tracked website visiting behaviors;
providing a compensatory reward related to a tracked quantity as is stored in the account.

2. The method of claim 1 wherein determining that a website visitor is an enrolled visitor comprises, at least in part:
receiving from the website visitor at least one personal identifier;
using the at least one personal identifier to verify that the website visitor is an enrolled visitor.

3. The method of claim 1 wherein automatically tracking website visiting behaviors of the enrolled visitor as pertain to a selected category of behavior comprises, at least in part, automatically tracking web content exposure events as correspond to the enrolled visitor.

4. The method of claim 3 wherein the web content exposure events comprise, at least in part, tracking a duration of the enrolled visitor's exposure to content at a given website.

5. The method of claim 3 wherein the web content exposure events comprise, at least in part, at least one of selecting a webpage that includes particular content.

6. The method of claim 5 wherein the particular content comprises advertising content.

7. The method of claim 1 wherein providing a compensatory reward comprises providing the compensatory reward to the website visitor.

8. The method of claim 7 wherein providing the compensatory reward to the website visitor comprises providing the compensatory reward using legal tender.

9. The method of claim 7 wherein providing the compensatory reward to the website visitor comprises providing at least one of the following:
a virtual currency;
a promissory note;
a check;
cash;
a direct debit deposit;
an account credit;
a bank transfer;
a share of stock.

10. The method of claim 7 wherein providing the compensatory reward to the website visitor comprises automatically providing the compensatory reward to the website visitor as a function of the tracked quantity in the account at least exceeding a predetermined threshold value.

11. The method of claim 7 wherein providing the compensatory reward to the website visitor comprises, at least in part:
determining statistical information regarding other website visitors' tracked website visiting behaviors;
using the statistical information to influence, at least in part, the compensatory reward for the website visitor.

12. The method of claim 1 wherein providing a compensatory reward comprises, at least in part, providing the compensatory reward to a third party as specified by the website visitor.

13. The method of claim 1 wherein automatically tracking website visiting behaviors of the enrolled visitor comprises automatically tracking website visiting behaviors of the enrolled visitor at any of a plurality of administratively unrelated websites and wherein automatically crediting an account for the enrolled visitor as a function, at least in part, of the tracked website visiting behaviors comprises automatically crediting the account for the enrolled visitor as a function, at least in part, of the tracked website visiting behaviors at any of the plurality of administratively unrelated websites.

14. The method of claim 1 wherein automatically crediting an account for the enrolled visitor as a function, at least in part, of the tracked website visiting behaviors further comprises automatically crediting the account for the enrolled visitor as a function, at least in part, of characterizing information regarding the enrolled visitor.

15. The method of claim 14 wherein automatically crediting the account for the enrolled visitor as a function, at least in part, of characterizing information regarding the enrolled visitor comprises, at least in part, crediting the account in an amount that is altered as a function of the characterizing information.

16. The method of claim 15 wherein the characterizing information comprises at least one of:
a credit report for the enrolled visitor;
reported income for the enrolled visitor;
reported occupation for the enrolled visitor;
demographic information for the enrolled visitor.

17. The method of claim 15 wherein the characterizing information comprises health care information for the enrolled visitor.

18. The method of claim 17 wherein the health care information comprises at least one of:
a condition with which the enrolled visitor is afflicted;
a condition with which the enrolled visitor has been afflicted in the past;
a condition for which the enrolled visitor has an increased or decreased genetic predisposition;
a condition with which a relative of the enrolled visitor is afflicted;
a condition with which an acquaintance of the enrolled visitor is afflicted;
primary health caregiver status of the enrolled visitor;
a medication prescribed for the enrolled visitor;
a laboratory test ordered for the enrolled visitor;
a laboratory test result of the enrolled visitor;
an imaging test ordered for the enrolled visitor;
an imaging test result of the enrolled visitor;
an allergy of the enrolled visitor;
a preventive health intervention status for the enrolled visitor;
an immunization status of the enrolled visitor;
a specific health care services provider who has provided health care services to the enrolled visitor;
a specific health care services provider specialty which has provided health care services to the enrolled visitor;
a medical procedure status for the enrolled visitor;
health insurance status of the enrolled visitor;
a risk factor for a condition as relates to the enrolled visitor;
a dietary regimen of the enrolled visitor;
a geographic location visited by the enrolled visitor;
a geographic location the enrolled visitor is planning to visit;
participation status of the enrolled visitor in a medical research study.

19. The method of claim 1 further comprising:
automatically tracking website visiting behaviors of the enrolled visitor as pertain to a selected category of undesired behaviors to provide tracked website undesired visiting behaviors;
automatically taking a pejorative action with respect to the account for the enrolled visitor as a function of the tracked website undesired visiting behaviors.

20. The method of claim 19 wherein to the undesired behaviors comprise at least one of:
excessively high clicking frequencies;
excessively large numbers of clicks in a given time period;
large numbers of repeat clicks on a same item;
a failure of the website visitor to pass a screening test that tests if clicks are being automatically created;
large numbers of clicks for a given website visitor from an excessive variety of Internet Protocol (IP) addresses;
simultaneous clicks by a single enrolled visitor in multiple sessions; and
clicking events that occur without interruption for too long a time.

21. An apparatus comprising:
a network interface;
a processor operably coupled to the network interface and being configured and arranged to:
determine that a website visitor is an enrolled visitor;
upon determining that the website visitor is an enrolled visitor:
automatically tracking website visiting behaviors of the enrolled visitor as pertain to a selected category of behavior to provide tracked website visiting behaviors;
automatically crediting an account for the enrolled visitor as a function, at least in part, of the tracked website visiting behaviors;
provide a compensatory reward related to a tracked quantity as is stored in the account.
